(19) United States
(12) Patent Application Publication
(10) Pub. No.: US 2015/0090127 A1
(43) Pub. Date: Apr. 2, 2015

(54) INFUSER AND AN INFUSION-CONTAINER LIFTING STRUCTURE THEREOF

(71) Applicant: Ningbo SMAL Electrics Co., LTD., Zhejiang (CN)

(72) Inventors: Yuejun DONG, Zhejiang (CN); Shaole WEI, Zhejiang (CN)

(73) Assignee: Ningbo SMAL Electrics Co., LTD., Zhejiang (CN)

(21) Appl. No.: 14/150,241

(22) Filed: Jan. 8, 2014

(30) Foreign Application Priority Data
Sep. 27, 2013 (CN) 201320602436.9

(51) Int. Cl. A47J 31/06; A47J 31/44

(52) U.S. Cl. CPC A47J 31/0636; A47J 31/4439
USPC 99/288; 99/319

(57) ABSTRACT

The disclosure relates to an infuser and an infusion-container lifting structure thereof. The infusion-container lifting structure is used in an infuser and comprises a cover body placed in a top opening of the infuser, a lifting button provided at an upper surface side of the cover body, an infusion container for accommodating an infusion and provided at a lower surface side of the cover body, a lifting shaft configured to extend through the cover body and have one end fixed to the infusion container and the other end fixed to the lifting button, and a clip assembly arranged in the cover body, with one end fixed to the cover body and the other end pressed against the lifting shaft elastically such that the lifting shaft is slidable under an external force and maintained at its position when the external force is released. With the disclosure, the user will feel comfortable when manually lifting and lowering the infusion container in use. Moreover, it is simple in configuration, easy to manufacture, reliable in use, and implement with a low cost.

### TECHNICAL FIELD

The present disclosure relates to an infuser such as a tea pot or a tea maker, and more particularly, to an infuser having an infusion-container lifting structure.

### BACKGROUND

Conventional infusers exist in various forms. Recently, for the convenience of a user, individual infusion containers are provided in some infusers for accommodating an infusion, such as tea, coffee, traditional Chinese medicines and the like, so that the infusion will not mix into the infused drink. Some infusers are also designed as electric infusers so as to directly heat the liquid therein. Furthermore, some infusers are designed to be transparent or translucent, for assisting the user to observe the infusion state therein, in addition to aesthetic consideration.

In the related art, there is an electric tea pot comprising a glass pot body for containing liquid, an exothermic plate for heating, a handle provided on the pot body, a cover for covering a pot opening of the pot body, an infusion container (also referred to as a pot) for containing tea, and a relevant cover-opening mechanism and sealing mechanism, etc. In order to facilitate to tea infusion, a lifting of the infusion container of the electric tea pot is achieved mainly by manual lifting and rotational positioning, yet this kind of lifting mode is not only inconvenient in operation but also the user is unable to position as desired. Moreover, the manufacturing cost is relatively high because of the complicated configuration.

In order to solve the problem of inconvenient operation, an automatic infuser that is able to electronically control the infusion container to move up-and-down automatically inside the infuser is used. However, this infuser has a very complicated structure and is expensive.

### SUMMARY

In order to solve one or more of the above-mentioned deficiencies in the related art, an objective of the disclosure is to provide an infusion-container lifting structure and an infuser having the same, such that it is easier for an infusion container to be moved up-and-down in the infuser and maintained at a desired position only through a manual lifting operation, which is simple in structure, reliable in use, and lower in cost.

In order to achieve the above objective, according to one aspect of the present disclosure, there is provided an infusion-container lifting structure used in an infuser comprising: a cover body in a top opening of the infuser; a lifting button at an upper surface side of the cover body; an infusion container for accommodating an infusion at a lower surface side of the cover body; a lifting shaft configured to extend through the cover body and have one end fixed to the infusion container and the other end fixed to the lifting button; and a clip assembly arranged in the cover body, with one end fixed to the cover body and the other end pressed against the lifting shaft elastically such that the lifting shaft is slidable under an external force and maintained at its position when the external force is released.

According to another aspect of the present disclosure, the disclosure also provides an infuser, comprising a pot body, a heating plate (for example, a heating coil) on which the pot body is placed, and an infusion-container lifting structure according to the disclosure arranged in the pot body.

In an embodiment, a plurality of clip assemblies are disposed uniformly in a circumferential direction around the lifting shaft.

In an embodiment, the cover body comprises an upper cover body and a lower cover body coupled with each other, as well as a mount arranged on the upper cover body. In addition, the clip assembly may be arranged between the upper cover body and the mount, and may comprises: a fixing frame between the upper cover body and the mount, having a through hole through both ends thereof; an elastic member disposed in the through hole, having one end fixed to the mount; and a ball, rollably disposed in the through hole and supported by the other end of the elastic member such that a portion of the ball protrudes from the through hole to press against the lifting shaft.

In an embodiment, a positioning groove is disposed on the upper cover body and another positioning groove corresponding to the positioning groove is disposed on the mount, for placing the fixing frame.

In an embodiment, a conical surface is formed at an end portion of the through hole adjacent to the lifting shaft so as to prevent the ball from detaching from the through hole.

In an embodiment, the lifting shaft is provided with at least one notch, and the ball is slidable into or out of the notch during the sliding of the lifting shaft.

In an embodiment, the notch is an annular U-shaped groove.

In an embodiment, the U-shaped groove is disposed at an end of the shaft close to the infusion-container.

In an embodiment, the infuser is an electric glass tea pot.

Accordingly, the infusion-container lifting structure and the infuser of the present disclosure have at least one of the following advantageous effects: the infusion-container lifting structure will make the user feel comfortable to use and easier to manufacture, has a long lifetime, is reliable in use and implementable with a low cost.

### BRIEF DESCRIPTION OF THE DRAWINGS

The accompanying drawings, which are included to provide a further understanding of the disclosure and are incorporated in and constitute a part of this specification, illustrate exemplary embodiments and together with the description serve to explain the principles of the disclosure, without intending to limit the disclosure. In the drawings,

FIG. 1 is a schematic perspective view of an infuser according to the present disclosure, which is implemented as an electric tea pot;

FIG. 2 is a schematic perspective exploded view of the electric tea pot shown in FIG. 1 according to the disclosure;

FIG. 3 is a schematic perspective view of an infusion-container lifting structure in the electric tea pot shown in FIGS. 1 and 2;

FIG. 4 is a schematic perspective view of the infusion-container lifting structure shown in FIG. 3 in a state;

FIG. 5 is a schematic perspective view of the infusion-container lifting structure shown in FIG. 3 in another state;

FIG. 6 is a schematic perspective exploded view of the infusion-container lifting structure;

FIG. 7 is a perspective exploded view of the clip assemblies and a lifting shaft;

FIG. 8 is a schematic section view of the infusion container lifting structure shown in FIG. 3;

FIG. 9 is a schematic section view of the infusion container lifting structure shown in FIG. 4;

FIG. 10 is a perspective view of the infusion container lifting structure when a lifting button and a mount are removed;

FIG. 11 is a section view of the state that the ball slides into a U-shaped groove; and

FIGS. 12 to 14 illustrate schematic views of the infusion-container lifting structure at different positions within the pot body, respectively.

Wherein:

1 electric tea pot;

10 infusion-container lifting structure;

11 lifting button;

111 lifting plate;

112 projection;

113 cap;

12 mount;

123 recess;

13 cover body ornamental ring;

14 cover body;

141 upper cover body;

142 lower cover body;

143 opening;

145 inside wall;

146 outside wall;

150 clip assembly;

151 fixing frame;

152 ball;

153 spring;

154 through hole;

16 spring member;

17 press-fit element;

18 tea holder;

181 first lid;

182 second lid;

183 tea basket;

19 lifting shaft;

191 U-shaped groove;

20 pot body;

21 pot opening;

22 pot stomach;

30 heating plate;

31 control button;

40 handle;

S accommodating space.

### DETAILED DESCRIPTION OF THE EMBODIMENTS

Description will now be given in detail of the exemplary embodiments of the infuser and the infusion-container lifting structure thereof according to the disclosure. Hereinafter, for convenience of illustrating the design concept of the disclosure, an electric tea pot having an infusion-container lifting structure according to the disclosure is exemplified. However, the infuser of the disclosure is not limited to the electric tea pot, and, in particular, can also be applied to an electric coffee pot, an electric medicine pot or a pot without an electric heating function.

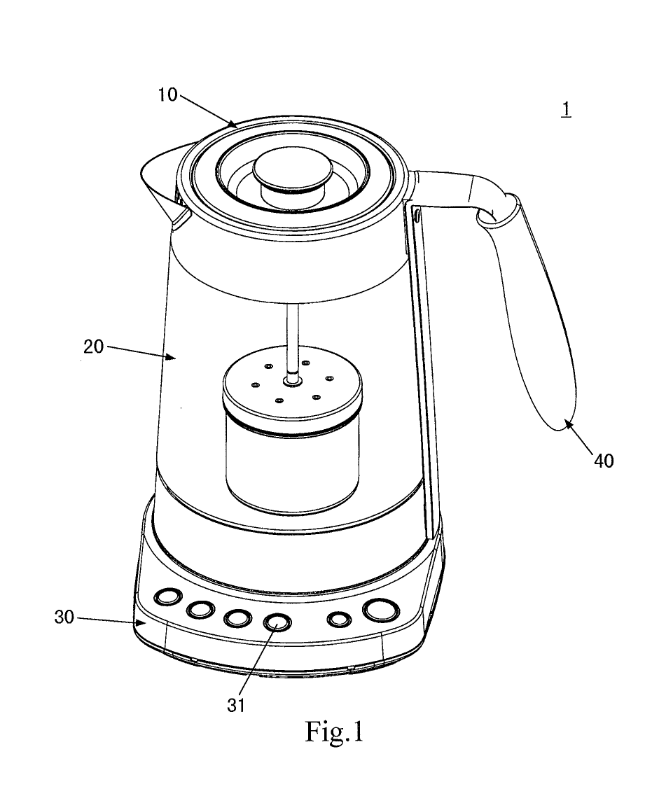

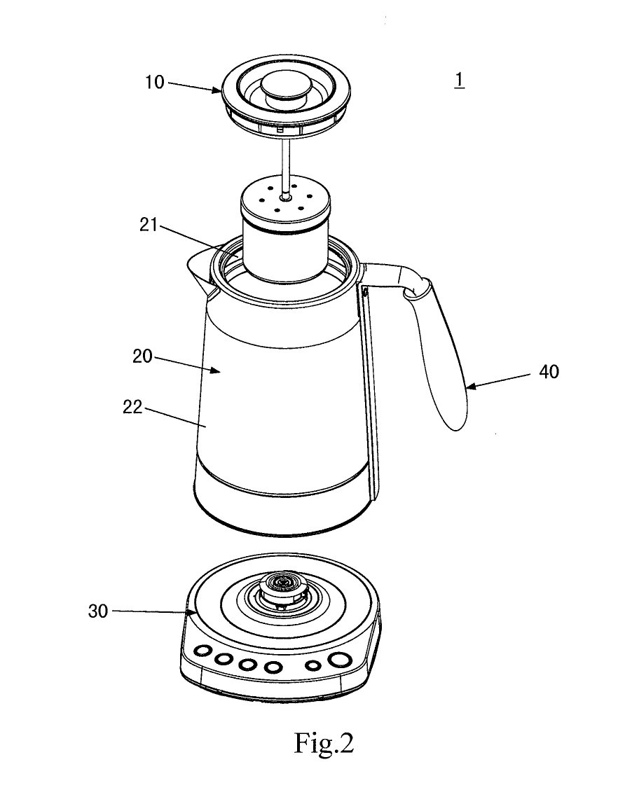

Reference is made to FIGS. 1 and 2, which are a schematic perspective view and a perspective exploded view of the electric tea pot 1, respectively. The electric tea pot 1 generally comprises an infusion-container lifting structure 10, a pot body 20 for containing a liquid, a heating plate 30 and a handle 40 for gripping.

An opening, hereinafter referred to as a pot opening 21, is provided on the top of the pot body 20, and is covered by the infusion-container lifting structure 10 which may extend into the pot opening 21 and be upwardly moved away off the pot opening 21. In an embodiment, the pot body 20 has a pot stomach 22 made of transparent glass. However, except for the transparent pot stomach 22, it is apparent that the pot body 20 may have a translucent or opaque pot stomach made of, for example, stainless steel, ceramic, plastic, etc. For the pot body 20, one or more visible windows, for example, in the shape of a vertical strip with a certain width, may be provided to the translucent or opaque pot stomach according to the requirements, so that the user may observe the liquid within the pot body 20.

A plurality of control buttons 31 are provided to the heating plate 30 to control the operation of the electric tea pot 1. A female connector is provided to the bottom of the pot body 20, while a male connector is provided to the top of the heating plate 30, or vice versa. When the electric tea pot 1 is in use, the heating plate 30 is supplied with electric power to heat the liquid inside the pot body 20 after the pot body 20 is placed at the right position on the heating plate 30. As the configuration of the heating plate 30 and the technique for heating the pot body 20 are well known, the description thereof is omitted.

Hereinafter, description will be made in detail to the infusion-container lifting structure 10 according to the disclosure.

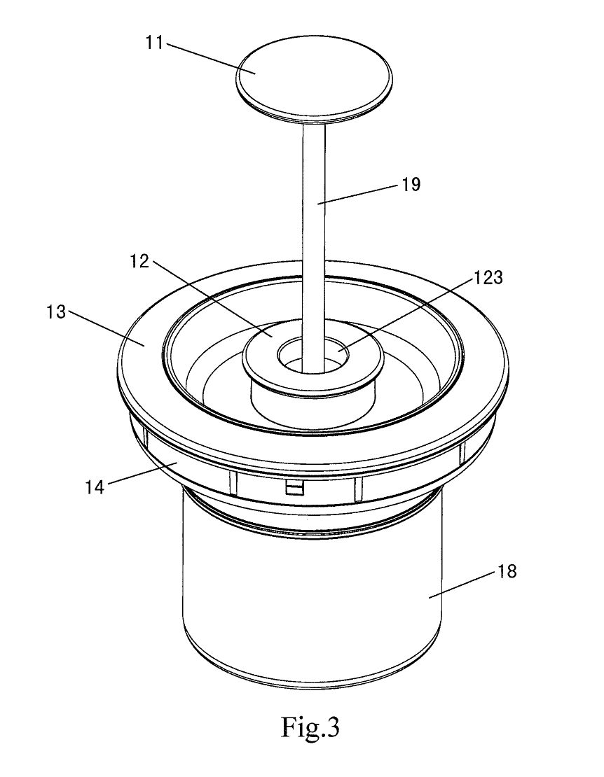

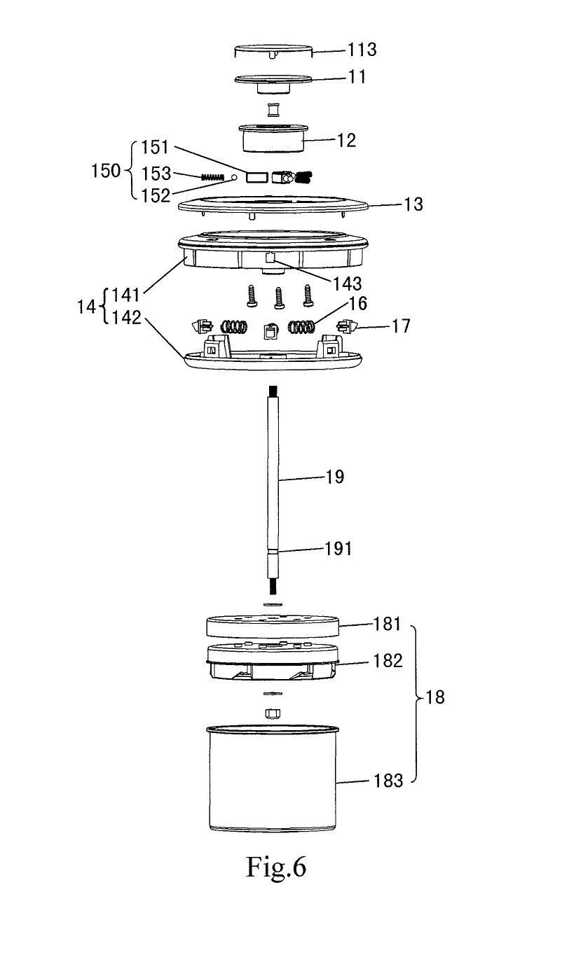

Reference is made to FIGS. 3 to 5, which are schematic perspective views of the infusion-container lifting structure 10 at different positions, respectively; reference is still made to FIG. 6, which is a schematic perspective exploded view of the infusion-container lifting structure 10.

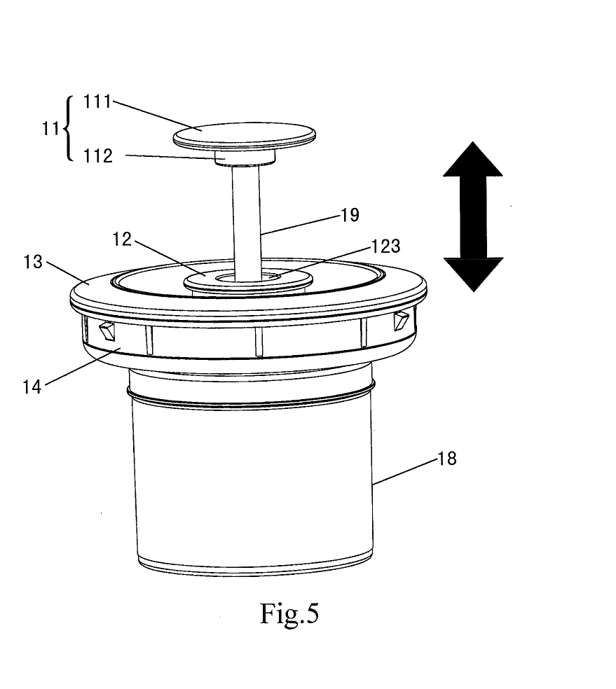

Referring to the above drawings, the infusion-container lifting structure 10 according to the disclosure mainly comprises: a cover body 14 placed at the top opening (i.e. the pot opening 21) of the electric tea pot; a lifting button 11 provided at an upper surface side of the cover body 14; a tea holder 18 used as an infusion container and provided at the lower surface side of the cover body 14; a lifting shaft 19 configured to extend through the cover body 14 and has one end fixed to the tea holder 18 and the other end fixed to the lifting button 11; and a plurality of clip assemblies 150, which are fixed in the cover body 14 and disposed evenly in circumferential direction around the lifting shaft 19, such that the lifting shaft 19 can be maintained at any required position by means of the clip assemblies 150. It should be noted, as an example, the present embodiment illustrates three clip assemblies, however, the number of the clip assemblies may be designed as two, four or more. In use, the tea holder 18 can be moved up-and-down in the direction of the double arrow shown in FIG. 5 via the lifting shaft 19 by lifting the lifting button 11, and, if necessary, the tea holder 18 can be located at any position in the stroke by the means of the clip assemblies 150. In practice, it is obvious to those skilled in the art that the number of the clip assemblies 150 is not limited to the above examples. In addition, any number of the clip assemblies 150 may be arranged around the circumference, as long as the clip assemblies enable the lifting shaft 19 to be held at any required position steadily and to be slidable up-and-down when a sufficient acting force is applied to the lifting button 11.

The lifting button 11 is substantially constituted by a lifting plate 111 and a projection 112 provided at a middle portion of the lower side of the lifting plate 111. In an embodiment, a protection cap 113 may be disposed above the lifting button 11, as shown in FIG. 6.

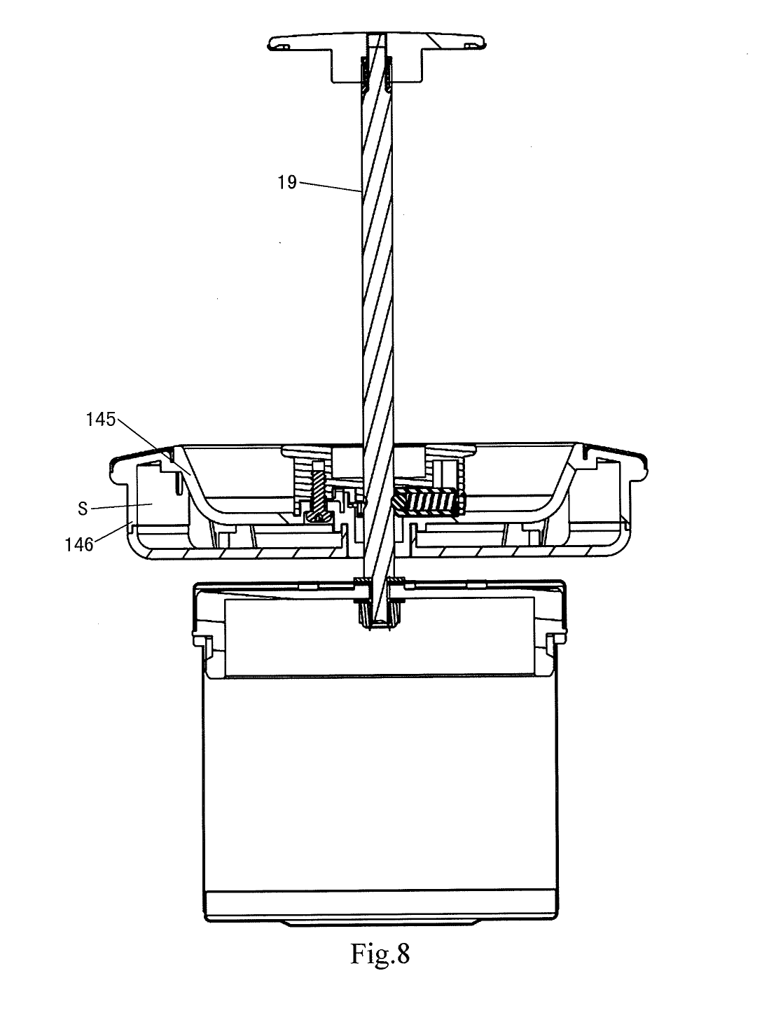

The cover body 14 is placed in the pot opening 21 of the electric tea pot 1 and is composed of an upper cover body 141 and a lower cover body 142 in a known joint manner such as by press-fit. In FIG. 6, for example, a plurality of protrusions are provided on the lower cover body 142 and a plurality of grooves are provided on the upper cover body 141 at corresponding positions. An accommodating space S is also formed between the upper cover body 141 and the lower cover body 142 (see FIG. 8).

The cover body 14 also includes a mount 12 above the upper cover body 141. The mount 12 is substantially in the shape of a hollow cylinder and is connected to the upper cover body 141 by means of a connection means as known, such as a bolt. A recess 123 is provided to the top surface of the mount 12 to accommodate the projection 112 of the lifting button 11 with a clearance fit, so that the lifting button 11 can be inserted into and moved away from the mount 12 smoothly. In an embodiment, the diameter of the lifting plate 111 of the lifting button 11 should be slightly larger than that of the top surface of the mount 12.

The center of the top surface of the upper cover body 141 is depressed to form a recess, so that an annular space is formed between the upper cover body 141 and the mount 12, which provides an operation space for lifting the lifting button manually. A cover body ornamental ring 13 may be provided on the outer periphery of the top surface of the upper cover body 141. The lifting shaft 19 may be passed through the cover body 14 provided with the mount 12.

A plurality of spring members 16 and the corresponding press-fit elements 17 are provided uniformly within the accommodating space S of the cover body 14 in the circumferential direction. Each spring member 16 is contractible in the radial direction, and has one end pressed against the inner side of the inside wall 145 of the accommodating space S of the cover body 14 and the other end pressed against one end of the press-fit element 17. A stopper is provided at a middle portion of the press-fit element 17, and is pressed against the inner side of the outside wall 146 of the accommodating space S by the elasticity of the spring member 16 such that the other end of the press-fit element 17 is projected from the outer periphery of the cover body 14 through the corresponding opening 143 of the upper cover body 141. To this end, the press-fit element 17 may be stretched resiliently in the opening 143 by virtue of the cooperation of the external force and the spring member 16. It is to be noted that, in the present embodiment, while the number of the press-fit elements 17 and the spring members 16 is three, it can be changed as required.

Furthermore, the other end of the press-fit element 17 may be formed as an inclined surface, and when the cover body 14 is put into the pot opening 21 of the pot body 20, the press-fit elements 17 contact with the pot opening 21 firstly and then the spring members 16 are compressed to move into the accommodating space S by virtue of the press effect, so that the elastic restoring force of the spring members 16 react upon the press-fit elements 17 and thus block the press-fit elements 17 between the spring members 16 and the pot opening 21. In such a way, the cover body 14 can be stably placed in the pot body 20. If needed, the mount 12 may be pulled up directly to move the cover body 14 out of the pot opening 21. It is to be noted that the placement of the cover body 14 is not limited to the embodiments as described above, and can be placed in the pot opening via any other way such as threaded connection, press-fit, etc.

The tea holder 18 is substantially in the shape of a cylinder and the infusion is disposed therein. One end of the lifting shaft 19 is fixed to the tea holder 18, in particular, to a top lid of the tea holder 18. The top lid consists of a first lid 181 and a second lid 182, as well as a tea basket 183. The first lid 181 and the second lid 182 may be made from different materials, for example, the first lid 181 is made of metal and the second lid 182 is made of plastic. The top lid of the tea holder 18 is detachable from the tea basket 183 such that the infusion may be put into or removed from the tea holder 18. The other end of the lifting shaft 19 extends through the cover body 14 and is fixed to the projection 112 of the lifting button 11. As shown in FIG. 6, both ends of the lifting shaft 19 are provided with thread, so that the shaft 19 may be fixed to the lifting button 11 and tea holder 18 by means of the fasteners respectively. Accordingly, the lifting button 11, the lifting shaft 19 and the tea holder 18 are integrated as one piece.

Hereinafter, description of the clip assembly 150 will be given in detail with reference to the accompanying figures.

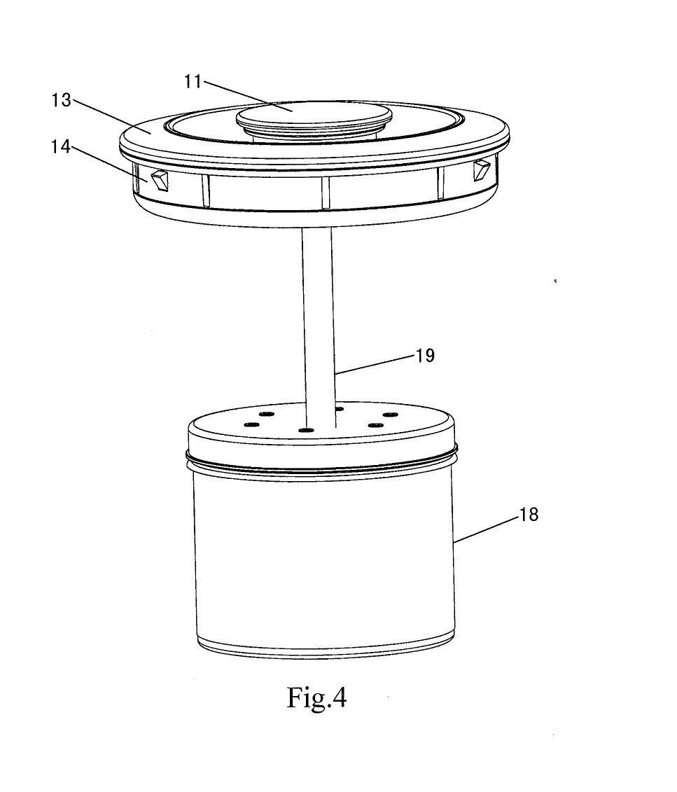

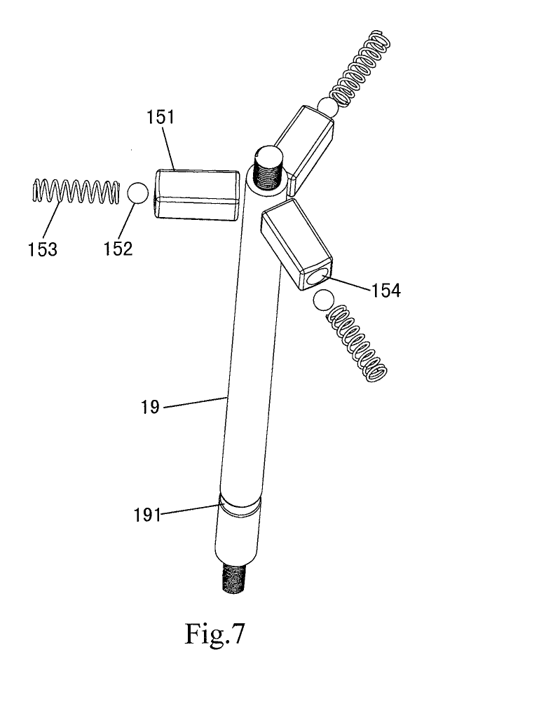

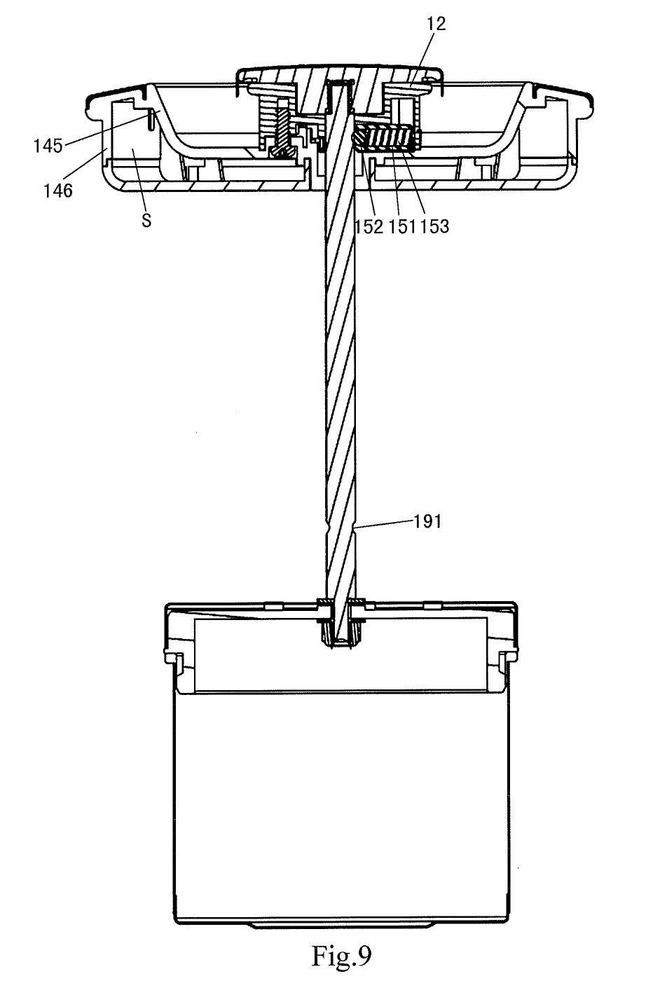

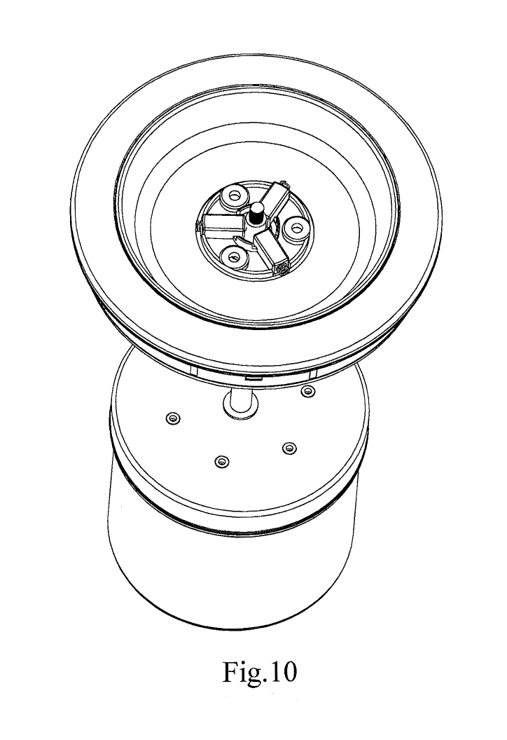

FIG. 7 is a perspective exploded view of the clip assemblies and the lifting shaft. FIG. 8 is a schematic section view of the infusion container lifting structure shown in FIG. 3. FIG. 9 is a schematic section view of the infusion container lifting structure shown in FIG. 4. FIG. 10 is a perspective view of the infusion container lifting structure after the lifting button and the mount is removed.

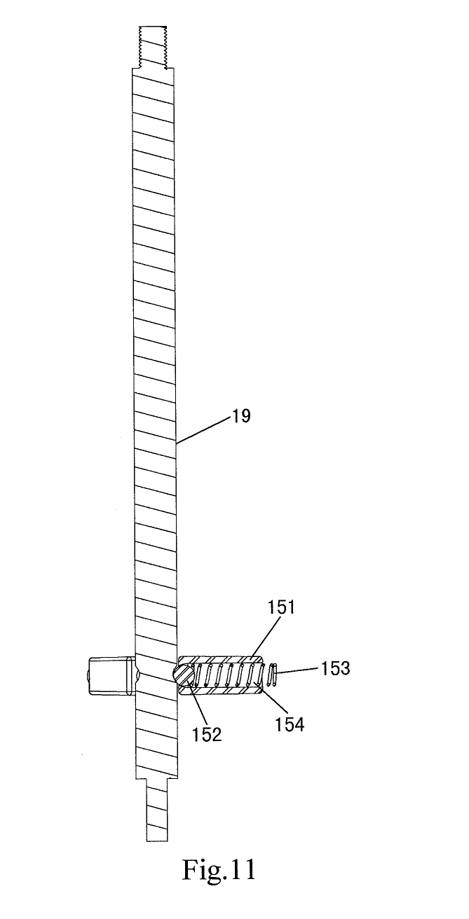

In particular, as shown in FIG. 7, three clip assemblies 150 are disposed evenly in the circumferential direction around the lifting shaft 19 and pressed against the lifting shaft 19 in the radial direction. Each clip assembly 150 includes a fixing frame 151, a ball 152 and a spring 153. The fixing frame 151 has a through hole 154 (see FIG. 11) through the both ends thereof. The diameter of the through hole 154 is slightly larger than that of the ball 152 and a generally conical surface is formed at the end portion of the through hole 154 adjacent to the lifting shaft 19, such that this end portion of the through hole 154 forms a conical hole tapering to the terminal of the through hole adjacent to the lifting shaft, and the ball 152 disposed in the through hole 154 may roll in the through hole 154 and protrude from the through hole 154 without rolling away from the through hole 154. The spring 153 is also disposed in the through hole 154, and the inner diameter of the spring 153 is slightly smaller than the diameter of the ball 152. One end of the spring 153 is fixed to the mount 12 and the other end thereof bears the ball 152, so that the ball 152 protrudes from the through hole 154 under the effect of the elasticity force and presses against the lifting shaft 19. As an example, the present embodiment of the disclosure illustrates the spring 153 for supporting the ball 152, however, a rubber element and other elastic member with elasticity are applicable.

Reference is made to FIGS. 8 and 9. The ball 152 is sandwiched between the lifting shaft 19 and the spring 153. The spring 153 is in a retracted state, such that the ball 152 partially protrudes from the end portion of the through hole 154 with a conical surface and continuously presses against the lifting shaft 19 all the time in the radial direction under the effect of the spring, and thereby the lifting shaft 19 is maintained at the desired position by means of the clip assemblies 150. When an external force exerted along the axial direction of the lifting shaft 19 is sufficient to overcome the friction between the lifting shaft 19 and the ball 152, it enables the lifting shaft 19 to move up-and-down, while the ball 152 rolls as the lifting shaft moves. When the movement of the lifting shaft 19 is stopped, the ball 152 stops rolling, and the lifting 19 is maintained at its position by virtue of the effect of the spring 153.

The clip assembly 150 is arranged between the mount 12 and the upper cover body 141. A plurality of positioning grooves are disposed on the upper cover body 141 and a plurality of corresponding positioning grooves are disposed on the mount 12, for placing a plurality of fixing frames 151 between the mount 12 and the upper cover body 141. FIG. 10 shows that there are positioning grooves on the upper cover body 141.

FIG. 11 is a section view of the state that the ball slides into a U-shaped groove. The lifting shaft 19 is provided with a notch such as a U-shaped groove 191 at one end thereof, for example, the lower end. The U-shaped groove serves as a stopper. For example, the depth of the U-shaped groove is smaller than the radius of the ball 152. When the tea holder 18 moves to the highest position shown in FIG. 8, the ball protrudes from the fixing frame 151 and slides into the U-shaped groove of the lifting shaft 19 to position the tea holder 18 at the upper limit position so as to prevent the tea holder 18 from moving up-and-down; when the lifting shaft 19 is pressed to move downwards, the ball 152 may escape from the U-shaped groove easily and roll downwards. Certainly, other grooves same as or similar to the U-shaped groove can be designed at other portions of the lifting shaft 19, such as the middle portion of the lifting shaft 19 and so forth to ensure a more stable positioning.

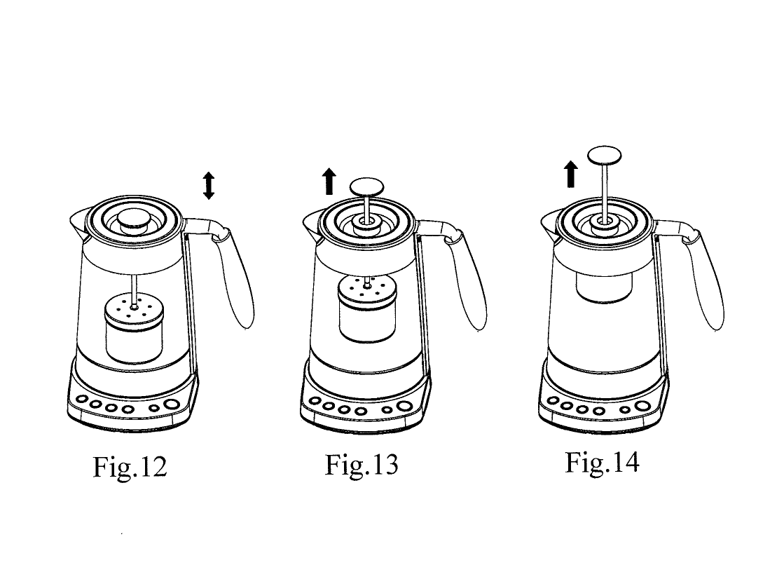

Reference is made to FIGS. 12 to 14, which illustrate schematic views of the infusion-container lifting structure 10 in different positions in the pot body, respectively. The tea holder 18 shown in FIG. 12 is at the lowest position, i.e. a lower limit position in the pot body 20, the tea holder 18 shown in FIG. 13 is at an optional position in the pot body 20, and the tea holder 18 shown in FIG. 14 is at the highest position, i.e. an upper limit position in the pot body 20.

In the use of the electric tea pot 1, for example, the tea holder 18 containing tea may be lifted up to the upper limit position by means of the lifting button 11 before the water in the pot body 20 is boiled. After the water in the pot body 20 is boiled, the lifting button 11 may be pressed downwards, such that the tea holder 18 is immersed into the boiling water. After that, the user may observe the color of the water and determine the time that the tea holder 18 is immersed in the boiling water according to personal interest. And then the lifting button 11 may be lifted to take the tea holder 18 out of the water, so the tea drink is made.

Although the infuser with the infusion-container lifting structure according to the disclosure is disclosed by an example of an electric tea pot, the disclosure is not limited thereto. With the disclosure, the user will feel comfortable when manually lifting and lowering the infusion container in use. Moreover, it is simple in configuration, easy to manufacture, reliable in use, and implementable with a low cost.

The above disclosure illustrates only the preferable embodiments of the disclosure, which are not intended to limit the protection scope of the application. Accordingly, all the equivalent variations or modifications made in view of the protection scope of the application are still embraced within the scope of the application.

What is claimed is:

1. An infusion-container lifting structure used in an infuser, characterized in that the infusion-container lifting structure comprises:
a cover body in a top opening of the infuser;
a lifting button at an upper surface side of the cover body;
an infusion container for accommodating the infusion at a lower surface side of the cover body;
a lifting shaft configured to extend through the cover body and have one end fixed to the infusion container and the other end fixed to the lifting button; and
a clip assembly arranged in the cover body, and the clip assembly has one end fixed to the cover body and the other end pressed against the lifting shaft elastically such that the lifting shaft is slidable under an external force and maintained at its position when the external force is released.

2. The infusion-container lifting structure according to claim 1, characterized in that a plurality of clip assemblies are disposed uniformly in a circumferential direction around the lifting shaft.

3. The infusion-container lifting structure according to claim 2, characterized in that the cover body comprises an upper cover body and a lower cover body coupled with each other as well as a mount arranged on the upper cover body, the clip assembly is arranged between the upper cover body and the mount and comprises:
a fixing frame between the upper cover body and the mount, having a through hole through both ends thereof;
an elastic member disposed in the through hole, having one end fixed to the mount; and
a ball rollably disposed in the through hole and supported by the other end of the elastic member such that the ball protrudes from the through hole to press against the lifting shaft.

4. The infusion-container lifting structure according to claim 3, characterized in that a positioning groove is disposed on the upper cover body and a corresponding positioning groove is disposed on the mount, for placing the fixing frame.

5. The infusion-container lifting structure according to claim 3, characterized in that a conical surface is formed at the end portion of the through hole adjacent to the lifting shaft so as to prevent the ball from detaching the through hole.

6. The infusion-container lifting structure according to claim 3, characterized in that the lifting shaft is provided with at least one notch, and the ball is slidable into or out of the notch during the sliding of the lifting shaft.

7. The infusion-container lifting structure according to claim 6, characterized in that the notch is an annular U-shaped groove.

8. The infusion-container lifting structure according to claim 7, characterized in that the U-shaped groove is disposed at an end of the shaft close to the infusion-container.

9. An infuser, comprising:
a pot body;
a heating plate, on which the pot body is placed; and
an infusion-container lifting structure according to claim 1 in the pot body.

10. The infuser according to claim 9, characterized in that the infuser is an electric glass tea pot.
